(19) United States
(12) Patent Application Publication
(10) Pub. No.: US 2019/0100154 A1
(43) Pub. Date: Apr. 4, 2019

(54) Smartphone Attachment Means with Magnetic Plate having Opposing Polarities

(71) Applicant: Ron Anisfeld, Herzelia (IL)

(72) Inventor: Ron Anisfeld, Herzelia (IL)

(21) Appl. No.: 15/538,196

(22) PCT Filed: Jun. 13, 2017
(86) PCT No.: PCT/IL2017/050653

§ 371 Date: Jun. 21, 2017

(30) Foreign Application Priority Data
Jun. 16, 2016 (IL) 246291

(51) Int. Cl. B60R 11/02; F16M 13/02; F16M 11/04; F16M 11/22

(52) U.S. Cl. CPC B60R 11/0241; F16M 13/02; B60R 2011/0063; F16M 11/22; F16M 11/04

(57) ABSTRACT

A magnetic attachment means for smartphone that includes a one single magnetic plate, a magnet casing and a metal plate. The one single magnetic plate has opposing diagonal polarities.

### TECHNICAL FIELD

The present invention relates to a magnetic attachment means for smartphones which designed to secure a smartphone to a dashboard of a vehicle or to any other object.

### BACKGROUND ART

There are known many standard magnetic attachment means for securing and attaching magnetically a smartphone to vehicle's dashboard. These standard magnetic attachment means create a strong magnetic field that damage the performance of many smartphone models. Some short term damages are darkening the screens, for example in some Samsung and Nexus models, and also causes the navigation systems to be less accurate. The present invention describes an innovative magnetic attachment means for smartphones that overcome the above-mentioned problem.

US patent application number 2013/0305497 discloses a permanent magnet panel fastener for attaching decorative panels to sheet metal parts of a vehicle body. This fastener use a magnet mounted to a surface of the decorative panel to attach this decorative panel to the metal part of the vehicle body. Within the scope of this, the US 2013/0305497 also discloses the possibility to use a multi-pole permanent magnet. However, the structure of the fastener of US 2013/0305497 differs from the attachment means subject matter of the present patent application and which also designed specifically for attaching Smartphones to the dashboard of the vehicle.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 depicts the smartphone (100) on which the metal plate (4) is attached.

FIG. 2 depicts the magnet casing (3).

FIG. 3 is a cross section view of the magnet casing (3).

FIG. 4 depicts the magnet plate with opposing diagonal polarities (2).

### THE INVENTION

The main objective of the present invention is to provide a magnetic attachment means for smartphone (100) that includes a metal plate (4) and a magnet casing (3). The metal plate (4) is designed to be attached to the smartphone (100) by adhesive layer. The magnet casing (3) includes a magnetic plate (2) and a supporting metal plate (5). The magnet casing (3) is designed to be magnetically attached to the metal plate (4).

The magnet casing (3) is designed to accommodate the magnetic plate (2). The rear surface (31) of the magnet casing (3) includes a double-sided adhesive pad to provide attachment of the casing (3) to the vehicle dashboard surface or the like. The metal plate (4) includes an adhesive layer to provide attachment of the plate (4) to the rear surface of the smartphone (100).

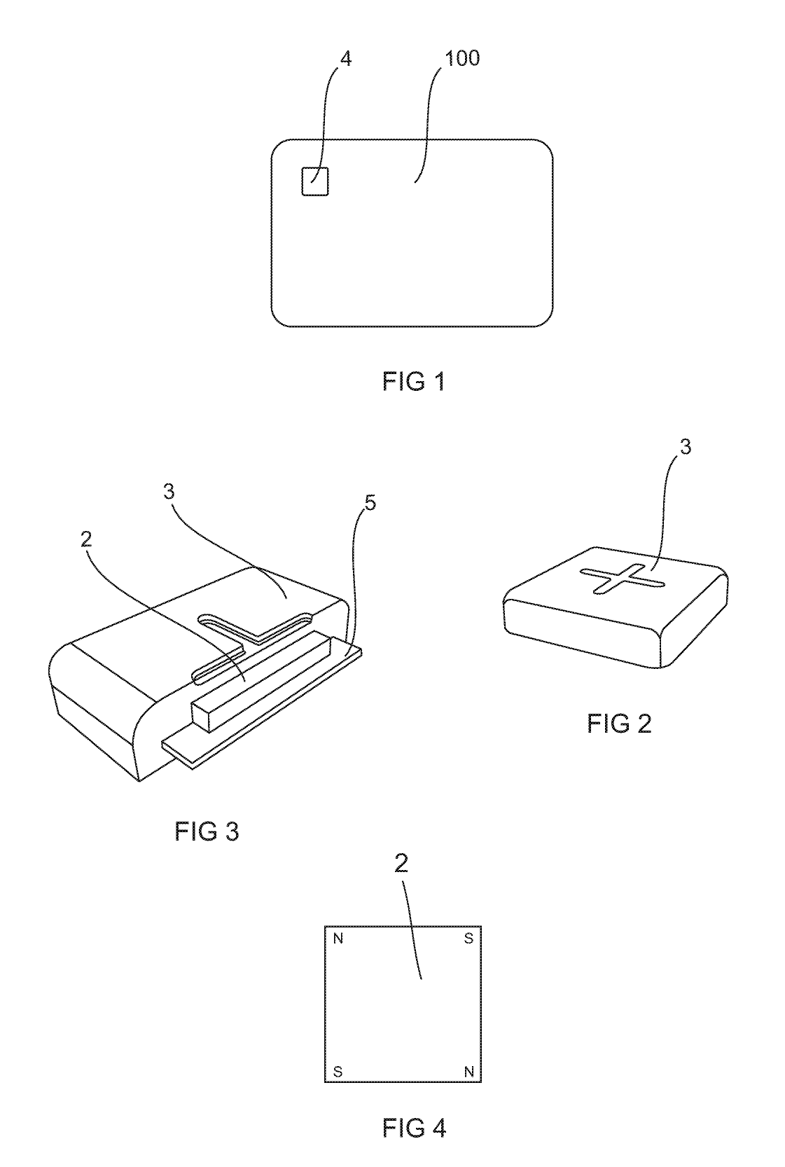

FIG. 1 depicts the smartphone (100) on which the metal plate (4) is attached. FIG. 2 depicts the magnet casing (3). FIG. 3 is a cross section view of the magnet casing (3) that enables to see the magnet plate (2) and the supporting metal plate (5).

The magnet casing (3), as it is understood from FIG. 2, includes the supporting metal plate (5), which is located between the magnet plate (2) to the rear surface (31) of the magnet casing (3). The role of this supporting metal plate (5) is to increase the magnetic attracting force of the magnetic plate (2). By that, it is possible to use less powerful and therefore less expensive magnetic plate for achieving the same magnetic attracting force.

The main innovative part of the present invention is the magnetic plate (2). But first, we will describe some details regarding the average standard magnets that used in standard magnetic attachment means for smartphones (“the average standard magnets”). In general, the magnetic attracting force (coupling force) of an average standard magnet is about 4 kg, i.e. it can couple to itself an object of 4 kg weight. In addition, the average standard magnet has about 2 or 3 centimeter square with correlative cross-section area. These characteristics define in general the magnitude of the magnetic field of the average standard magnet. Therefore, the inventor of the present invention applies the special magnet plate (2) to be the magnet of the magnetic attachment means subject matter of the present invention.

The magnet plate (2) is described schematically in FIG. 4. The magnet plate (2) made of a plate with multiple polarities arranged in configuration. The magnet plate (2) (an N50 metallic plate) is made of a plate which its four corners areas are magnetized with opposing polarities, to create a +−+− configuration as described in FIG. 4 (hereinafter “magnet plate with opposing diagonal polarities”).

A prototype of the magnetic attachment means with the magnetic plate with opposing diagonal polarities (2) was tested by using a Hall's probe and the results are that the magnitude of the magnetic field inside the smartphone was reduced to negligent levels.

Smartphone models that were affected by standard magnets of standard magnetic attachment means were tested with the magnetic attachment means subject matter of the present invention, and the results are that there are no effects on those models. In addition the alternate polarities seem to increase the magnetic attraction force of the magnetic plate (2) helping to secure the smartphone more firmly to the dashboard.

Therefore, it is understood from the above explanations, that the magnetic attachment means for smartphones provides the necessary magnetic attachment force for attaching the smartphone while the magnitude of the magnetic field of the magnetic attachment means is reduced to negligent levels. The standard magnet plate creates in its center a relatively high magnetic flux that reach inside the smartphone and badly affects its function. On the other hand, the magnet plate with opposing diagonal polarities ‘cancels’ this central magnetic flux and creates four relatively low magnetic flux that do not affectively reach inside the smartphone.

From the above explanations, it is clear that the present patent application describes also a method for magnetically attaching a smartphone to the vehicle dashboard. This method includes the following elements:

Providing the magnet casing (3) that contains the magnet plate with opposing diagonal polarities (2) and the supporting metal plate (5) that is located between the magnet plate with opposing diagonal polarities (2) to the rear surface (31) of the magnet casing (3).

Attaching the rear surface (31) of the magnet casing (3) to the vehicle dashboard surface by using a double-sided adhesive pad. Providing the metal plate (4) and attaching it to the rear surface of the smartphone (100) by the adhesive layer.

Whereby enabling a user to attach the smartphone to the dashboard by attaching the metal plate with the smartphone to the magnet casing which is attached to the dashboard; whereby said magnet plate with opposing diagonal polarities creates limited magnetic flux that nevertheless provides an attracting force that attach the metal plate with the smartphone to the magnetic attachment means for smartphone.

What is claimed is:

1. A magnetic attachment means for smartphone, comprising: a metal plate and a magnet casing; wherein the magnet casing contains a magnet plate with opposing diagonal polarities and a supporting metal plate; wherein the supporting metal plate is located inside the magnet casing between the magnet plate with opposing diagonal polarities to a rear surface of the magnet casing;
wherein the rear surface of the magnet casing includes a double-sided adhesive pad for attaching said magnet casing to a vehicle dashboard surface; wherein said metal plate includes an adhesive layer for attaching said metal plate to a rear surface of the smartphone; wherein the magnet casing is designed to be magnetically attached to the metal plate and whereby attaching the smartphone to the dashboard;
whereby said magnet plate with opposing diagonal polarities creates limited magnetic flux that nevertheless provides an attracting force that attach the metal plate with the smartphone to the magnetic attachment means for smartphone.

2. A method for magnetically attaching a smartphone to a vehicle dashboard surface, comprising:
(a) providing a magnet casing that contains a magnet plate with opposing diagonal polarities and a supporting metal plate that is located between the magnet plate with opposing diagonal polarities to a rear surface of the magnet casing;
(b) attaching the rear surface of the magnet casing to the vehicle dashboard surface by using a double-sided adhesive pad;
(c) providing a metal plate and attaching it to a rear surface of the smartphone by an adhesive layer;
whereby enabling a user to attach the smartphone to the dashboard surface by attaching the metal plate with the smartphone to the magnet casing which is attached to the dashboard surface; whereby said magnet plate with opposing diagonal polarities creates limited magnetic flux that nevertheless provides an attracting force that attach the metal plate with the smartphone to the magnetic attachment means for smartphone.
